(19) United States
(12) Patent Application Publication
(10) Pub. No.: US 2014/0351315 A1
(43) Pub. Date: Nov. 27, 2014

(54) IDLE PROCESSING RESOURCE ALLOCATION IN A COMPUTING SYSTEM ACROSS A NETWORK TO BOOST PROCESSING CAPABILITY OF A DATA PROCESSING DEVICE THEREOF

(71) Applicant: NVIDIA Corporation, Santa Clara, CA (US)

(72) Inventor: Abdeali H. Panvelwala, Pune (IN)

(73) Assignee: NVIDIA Corporation, Santa Clara, CA (US)

(21) Appl. No.: 13/899,578

(22) Filed: May 22, 2013

(51) Int. Cl. H04L 29/08

(52) U.S. Cl. CPC H04L 67/10
USPC 709/203

(57) ABSTRACT

A method includes scanning, through a server, a number of client devices communicatively coupled thereto through a computer network for a processor thereof in an idle state, and allocating, through the server, the processor in the idle state to a client device requiring additional processing capability to establish a communication link between a client device corresponding to the processor in the idle state and the client device requiring the additional processing capability. The method also includes registering, through a driver component on the client device requiring the additional processing capability, the processor in the idle state with an operating system executing thereon following the establishment of the communication link. Further, the method includes transmitting, through the driver component, data to be processed through the processor in the idle state from the client device requiring the additional processing capability across the computer network following the registration.

### FIELD OF TECHNOLOGY

This disclosure relates generally to computing systems and, more particularly, to idle processing resource allocation in a computing system across a network to boost processing capability of a data processing device thereof.

### BACKGROUND

A data processing device (e.g., a desktop computer, a laptop computer, a tablet, a mobile device) may execute a computationally intensive application (e.g., a gaming application) thereon that requires additional processing power. A user of the data processing device may supplement processing power on the data processing device through, say, a graphics card inserted into a port of a motherboard thereof. However, a number of supplementary processors may be limited by the number of ports on the motherboard. The data processing device may, therefore, be extremely limited in a capability thereof to execute the computationally intensive application.

### SUMMARY

Disclosed are a method, a device and/or a system of idle processing resource allocation in a computing system across a network to boost processing capability of a data processing device thereof.

In one aspect, a method includes scanning, through a server, a number of client devices communicatively coupled to the server through a computer network for a processor thereof in an idle state based on activity therein falling below a threshold beyond a threshold period of time. Each of the number of client devices includes a processor communicatively coupled to a memory. The method also includes allocating, through the server, the processor in the idle state to a client device requiring additional processing capability to establish a communication link between a client device corresponding to the processor in the idle state and the client device requiring the additional processing capability. Further, the method includes registering, through a driver component on the client device requiring the additional processing capability, the processor in the idle state with an operating system executing thereon following the establishment of the communication link, and transmitting, through the driver component, data to be processed through the processor in the idle state from the client device requiring the additional processing capability across the computer network following the registration.

In another aspect, a non-transitory medium, readable through a server and including instructions embodied therein that are executable through the server, is disclosed. The non-transitory medium includes instructions to scan a number of client devices communicatively coupled to the server through a computer network for a processor thereof in an idle state based on activity therein falling below a threshold beyond a threshold period of time. Each of the number of client devices includes a processor communicatively coupled to a memory. The non-transitory medium also includes instructions to allocate the processor in the idle state to a client device requiring additional processing capability to establish a communication link between a client device corresponding to the processor in the idle state and the client device requiring the additional processing capability.

Further, the non-transitory medium includes instructions to enable registering, through a driver component on the client device requiring the additional processing capability, the processor in the idle state with an operating system executing thereon following the establishment of the communication link, and instructions to enable transmitting, through the driver component, data to be processed through the processor in the idle state from the client device requiring the additional processing capability across the computer network following the registration.

In yet another aspect, a system includes a number of client devices, a computer network and a server communicatively coupled to the number of client devices through the computer network. Each of the number of client devices includes a processor communicatively coupled to a memory. The server is configured to scan the number of client devices for a processor thereof in an idle state based on activity therein falling below a threshold beyond a threshold period of time, and to allocate the processor in the idle state to a client device requiring additional processing capability to establish a communication link between a client device corresponding to the processor in the idle state and the client device requiring the additional processing capability.

A driver component on the client device requiring the additional processing capability is configured to enable registering the processor in the idle state with an operating system executing thereon following the establishment of the communication link, and transmitting data to be processed through the processor in the idle state from the client device requiring the additional processing capability across the computer network following the registration.

The methods and systems disclosed herein may be implemented in any means for achieving various aspects, and may be executed in a form of a non-transitory machine-readable medium embodying a set of instructions that, when executed by a machine, cause the machine to perform any of the operations disclosed herein.

Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a computing system, according to one or more embodiments

FIG. 2 is a schematic view of interaction between a driver component of a client device of the computing system of FIG. 1 and a processor and/or a display unit thereof, according to one or more embodiments.

FIG. 3 is a flowchart detailing the operations involved in processing resource allocation/deallocation in the computing system of FIG. 1, according to one or more embodiments.

FIG. 4 is a process flow diagram detailing the operations involved in idle processing resource allocation in the computing system of FIG. 1 across a network to boost processing capability of a data processing device thereof, according to one or more embodiments.

Other features of the present embodiments will be apparent from the accompanying drawings and from the detailed description that follows.

### DETAILED DESCRIPTION

Example embodiments, as described below, may be used to provide a method, a device, and/or a system of idle processing resource allocation in a computing system across a network to boost processing capability of a data processing device thereof. Although the present embodiments have been described with reference to specific example embodiments, it will be evident that various modifications and changes may be made to these embodiments without departing from the broader spirit and scope of the various embodiments.

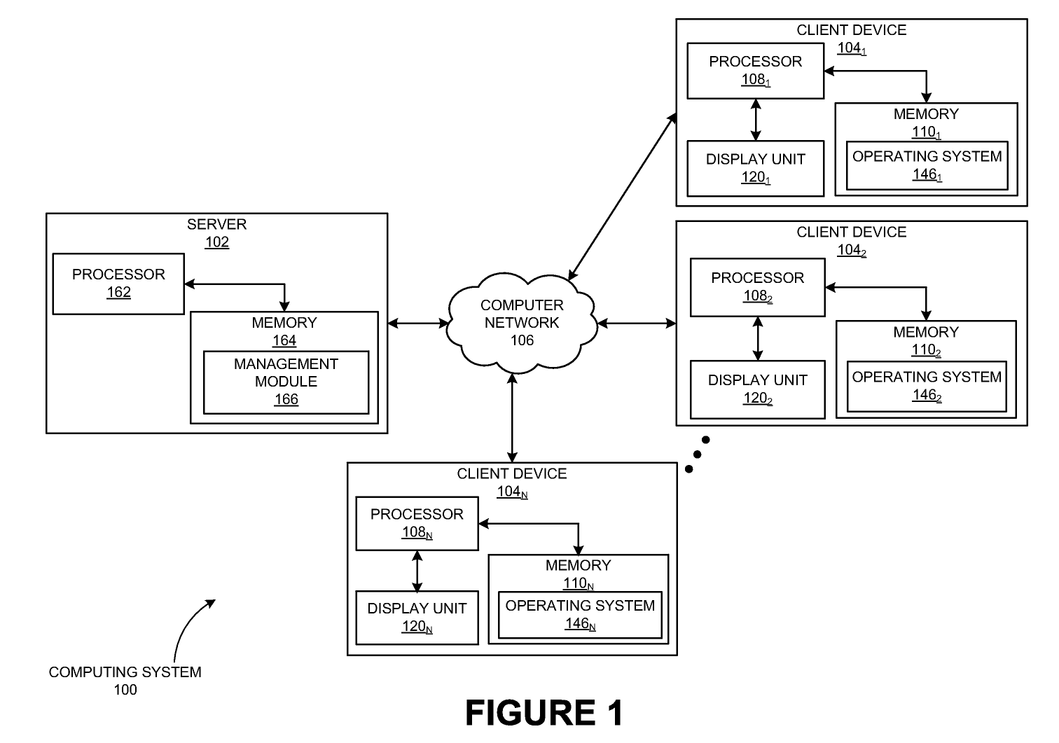

FIG. 1 is a schematic diagram of a computing system 100, according to one or more embodiments. In one or more embodiments, computing system 100 may include a server 102 communicatively coupled to a number of client devices 104_{1-N} (e.g., a laptop computer, a desktop computer, a notebook computer, a netbook, a tablet, a mobile device) through a computer network 106. In one or more embodiments, computer network 106 may be a wired and/or a wireless network; specific examples of computer network 106 may include a Local Area Network (LAN), Internet and/or a Wide Area Network (WAN). In one or more embodiments, each of client devices 104_{1-N} may include a processor 108_{1-N} (e.g., a Central Processing Unit (CPU), a Graphics Processing Unit (GPU)) communicatively coupled to a memory 110_{1-N} (e.g., a volatile memory and/or a non-volatile memory).

In one or more embodiments, output data associated with processing through processor 108_{1-N} may be input to a multimedia processing unit (not shown) configured to perform encoding/decoding associated with the data. In one or more embodiments, the output of the multimedia processing unit may be rendered on a display unit 120_{1-N} (e.g., a Liquid Crystal Display (LCD) display, a Cathode Ray Tube (CRT) monitor) associated with client device 104_{1-N} through a multimedia interface (not shown) configured to convert the data to an appropriate format required by display unit 120_{1-N}.

In one or more embodiments, server 102 may also include a processor 162 communicatively coupled to a memory 164. In one or more embodiments, server 102 may execute a management module 166 (e.g., a set of instructions) thereon to control allocation of processing resources in computing system 100; FIG. 1 shows management module 166 as being stored in memory 164 of server 102 to be executed through processor 162. For example, a client device 104₂ may be executing a computationally intensive shader algorithm or a high-end game application that requires the capability of one or more processors 108_{1-N} of computing system 100 in addition to processor 108₂ thereof. In the case of GPUs, client device 104₂ may be limited to a fixed number thereof, as dictated by, say, a number of Peripheral Component Interconnect Express (PCIe) slots on a motherboard of client device 104₂. Thus, in one or more embodiments, management module 166 may be configured to enable scanning of GPUs (example processors 108_{1-N}) of computing system 100 to determine idle GPUs thereof.

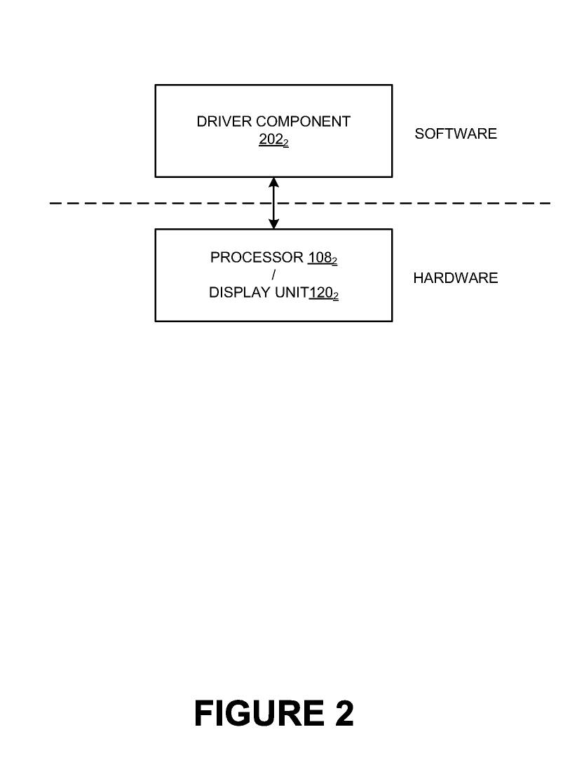

In one or more embodiments, each client device 104_{1-N} may include a driver component (a set of instructions; to be discussed in FIG. 2) associated with processor 108_{1-N} and/or display unit 120_{1-N}. In one or more embodiments, management module 166 on server 102 may execute instructions to register each of client device 104_{1-N} thereon. In one or more embodiments, registration and/or communication between server 102 and each client device 104_{1-N} may be based on an appropriate network communication protocol. For example, management module 166 may enable identification of client devices 104_{1-N} and routing of data therebetween based on Internet Protocol (IP) addresses thereof; said IP addresses may be obtained by server 102 through polling client devices 104_{1-N} therefor.

In one or more embodiments, management module 166 may be configured to enable pooling of processing resources of computing system 100; here, management module 166 may be configured to pool processors 108_{1-N} as logical resources. For the aforementioned purpose, the network communication protocol may be implemented with sufficient intelligence. In one or more embodiments, a client device (e.g., client device 104₂) may be configured to transmit a request to server 102 for an idle resource associated therewith. In one or more embodiments, management module 166 may process the aforementioned request and determine whether an idle processor 108₄ (other than processor 102₂) is available. Various methods of determining idleness of processors 108_{1-N} are within the scope of the exemplary embodiments discussed herein.

For example, clock cycles of processors 108_{1-N} and/or power consumption therethrough may be employed in determining states (e.g., active state, idle state) thereof. A test script may be loaded from server 102 (e.g., through management module 166) to be executed on each processor 108_{1-N}, based on which the idleness thereof may be determined. If activity through processor 108₄ falls below a threshold beyond a threshold period of time, management module 166 may deem said processor 108₄ to be in an idle state. In one or more embodiments, once server 102 deems processor 108₄ to be in the idle state, said processor 108₄ may be available as a logical resource through server 102 to client device 104₂.

In one or more embodiments, server 102 may then establish a channel between client device 104₂ and client device 104₄ having the idle processor 108₄ based on the network communication protocol. In one or more embodiments, the driver component on client device 104₂ may notify an operating system 146₂ executing thereon of an intent to register the idle processor 108₄ therewith; FIG. 1 shows an operating system 146_{1-N} as being stored in memory 110_{1-N} of each client device 104_{1-N}. In one or more embodiments, the registration may render processor 108₄ available to client device 104₂. In one or more embodiments, prior to the registration, client device 104₂ originating the request may be authenticated (e.g., based on an identifier thereof) through server 102 following the receipt of the request.

In one or more embodiments, once processor 108₄ is registered with operating system 146₂, the driver component of client device 104₂ may synchronize and transmit data over computer network 106 to accelerate processing of said data through processor 108₄ (in addition to processing through processor 108₂). Thus, in one or more embodiments, one client device 104₂ may utilize multiple processors 108_{1-N} (processor 108₂ thereof and idle processor 108₄, which now transits to an active state); low end processors 108_{1-N} may be pooled through computing system 100 to realize the benefits of high end processing therethrough.

In one or more embodiments, server 102 may be configured to pool idle processors 108_{1-N} thereon. In one or more embodiments, once an idle processor 108₄ is allocated to client device 104₂, said idle processor 108₄ may be removed from the pool on server 102. Thus, in one or more embodiments, the idle processor 108₄ may not be visible to client devices 104_{1-N} other than client device 104₂. In one or more embodiments, once the idle processor 108₄ is registered with client device 104₂, client device 104₂ may recognize the idle processor 108₄ as another device and utilize the capabilities thereof. Now, in one or more embodiments, whenever there is a request to server 102 for the previously idle and now active processor 108₄ (e.g., from another client device 104₃, same client device 104₄ originally having processor 108₄ in the idle state), management module 166 may be configured to construe the request as a request to decouple processor 108₄. Now, in one or more embodiments, server 102 may, in turn, transmit a request to client device 104₂ to decouple said processor 108₄. In one or more embodiments, the driver component on client device 104₂ may then notify operating system 146₂ thereon of an intent to decouple processor 108₄ therefrom, following which client device 104₂ completes a current operation thereof and then deregistering of processor 108₄ from operating system 146₂ occurs. Processor 108₄ may then be reallocated to client device 104₄. Also/alternately, client device 104₂ may automatically release processor 108₄ following completion of processing therethrough and notify server 102 of the availability of processor 108₄.

It should be noted that server 102 may provide an idle processor 108_{1-N} from the pool other than processor 108₄ to serve the request from client device 104₄; however, utilization of a processor 108_{1-N} other than processor 108₄ thereof across computer network 106 may be associated with latency. Therefore, serving of processor 108₄ to client device 104₄ may be first in an order of priority, followed by the serving of other idle processors 108_{1-N}. However, it should be noted that any serving of processing resources across computer network 106 is within the scope of the exemplary embodiments discussed herein.

Further, it should be noted that server 102 may be configured to allot processing resources (e.g., idle processors 108_{1-N}) to client devices 104_{1-N} dynamically based on the polling thereof without requiring client devices 104_{1-N} to transmit requests thereto. Also, server 102 may be one of client devices 104_{1-N}, for example, having an idle processor 108_{1-N}. Said client device 104_{1-N} having the idle processor 108_{1-N} may be designated as server 102. Now, when client device 104_{1-N} designated as server 102 requires utilization of processor 108_{1-N} thereof for rigorous processing (e.g., computation), another client device 104_{1-N} having an idle processor 108_{1-N} may be designated as server 102. Here, a number of client devices 104_{1-N} may execute management module 166 thereon. All reasonable variations are within the scope of the exemplary embodiments discussed herein.

FIG. 2 shows interaction between a driver component 202₂ of client device 104₂ and processor 108₂ and/or display unit 120₂ thereof, according to one or more embodiments. In one or more embodiments, driver component 202₂ may be associated with processor 108₂ and/or may be a display driver. As discussed above, in one or more embodiments, driver component 202₂ may be configured to notify operating system 146₂ of an intent to register the idle processor 108₄ as a device therewith. Further, in one or more embodiments, driver component 202₂ may be configured to enable deregistration of processor 108₄ upon processor 108₄ being requested for by another client device 104_{1-N}.

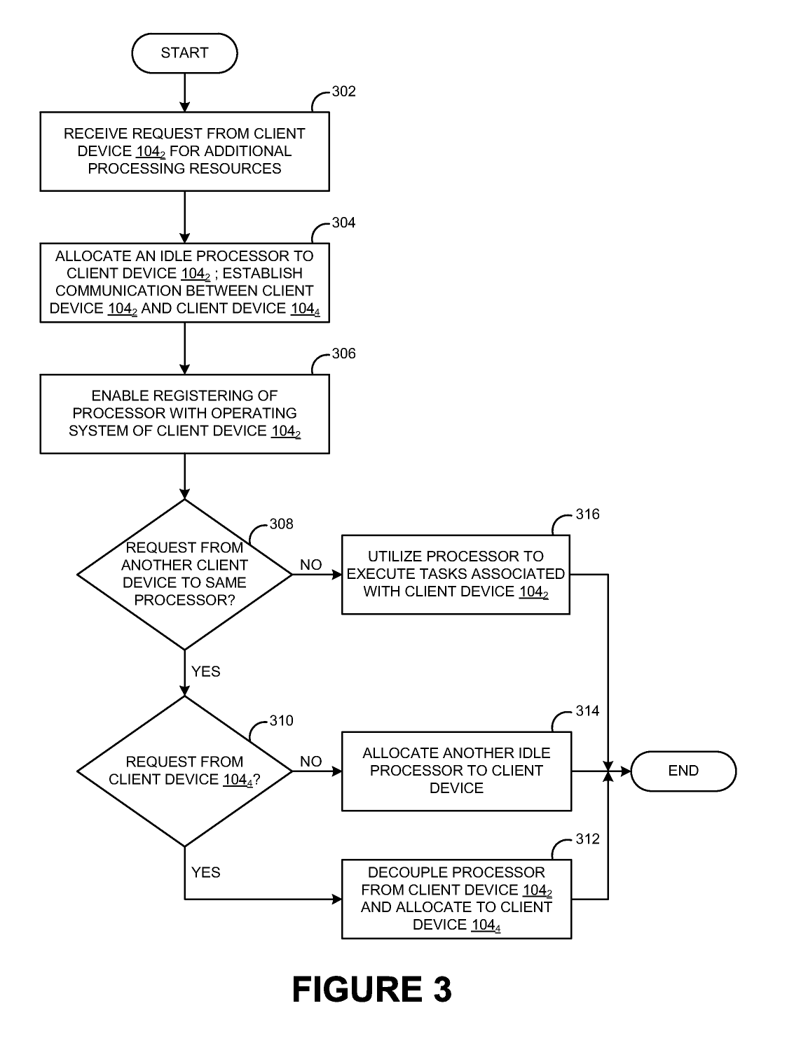

FIG. 3 shows a flowchart summarizing the processing resource allocation/deallocation discussed above, according to one or more embodiments. In one or more embodiments, operation 302 may involve receiving, at server 102, a request from client device 104₂ for additional processing resources available in computing system 100. In one or more embodiments, operation 304 may involve allocating an idle processor 108₄ in computing system 100 to client device 104₂, and establishing a communication link between client device 104₂ and client device 104₄ through computer network 106. In one or more embodiments, operation 306 may then involve driver component 202₂ on client device 104₂ enabling registering of processor 108₄ with operating system 146₂ thereon. In one or more embodiments, operation 308 may then involve checking as to whether processor 108₄ has a request therefor from another client device 104_{1-N}.

In one or more embodiments, if yes, operation 310 may involve checking as to whether the request is from client device 104₄. In one or more embodiments, if yes, operation 312 may then involve decoupling processor 108₄ from client device 104₂ after completing of processing tasks associated therewith and allocating processor 108₄ to client device 104₄. In one or more embodiments, if the result of operation 310 is a no, operation 314 may involve allocating another idle processor 108_{1-N} in computing system 100 to client device 104_{1-N} that is not client device 104₄. In one or more embodiments, if the result of operation 308 is a no, operation 316 may involve utilizing processor 108₄ to execute tasks associated with client device 104₂.

It should be noted that instructions associated with management module 166 may be tangibly embodied in a non-transitory medium (e.g., a Compact Disc (CD), a Digital Video Disc (DVD), a Blu-ray disc®, a hard drive; said instructions may be downloaded to the hard drive) readable through server 102. Exemplary embodiments may allow for a frame-buffer of a processor 108_{1-N} of a client device 104_{1-N} to be shared across another client device 104_{1-N} to accelerate graphics rendering on active display unit 120_{1-N} thereof.

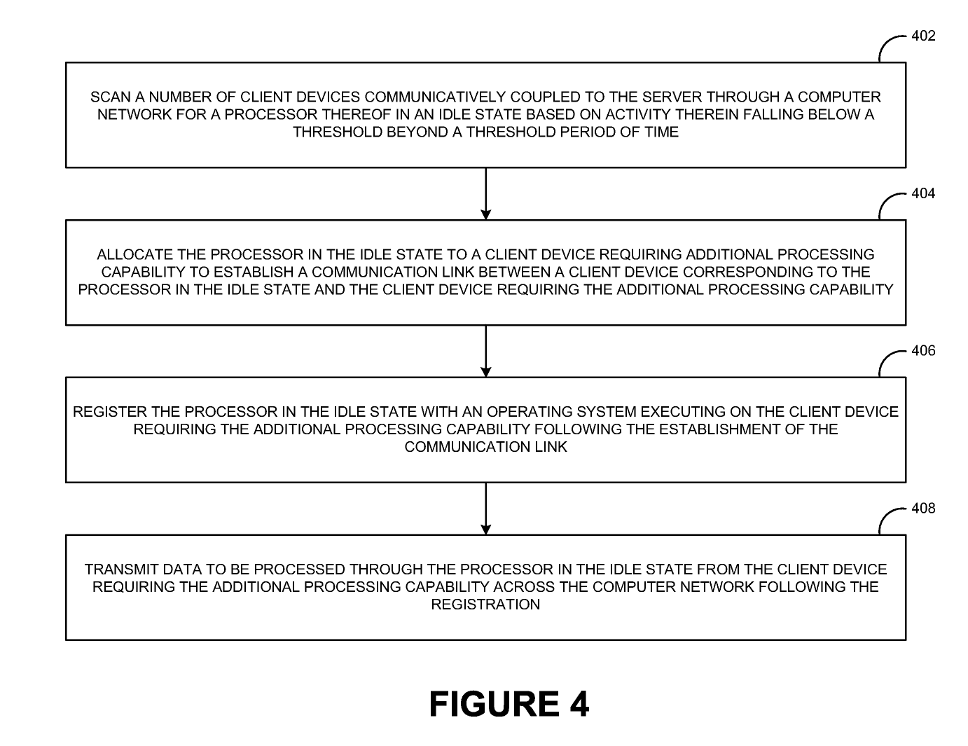

FIG. 4 shows a process flow diagram detailing the operations involved in idle processing resource allocation in computing system 100 across computing network 106 to boost processing capability of a data processing device (e.g., client device 104₂) thereof, according to one or more embodiments. In one or more embodiments, operation 402 may involve scanning, through server 102, a number of client devices 104_{1-N} communicatively coupled to server 102 through computer network 102 for a processor 108₄ thereof in an idle state based on activity therein falling below a threshold beyond a threshold period of time. In one or more embodiments, each of the number of client devices 104_{1-N} may include a processor 108_{1-N} communicatively coupled to a memory 110_{1-N}. In one or more embodiments, operation 404 may involve allocating, through server 102, processor 108₄ in the idle state to a client device 104₂ requiring additional processing capability to establish a communication link between a client device 104₄ corresponding to processor 108₄ in the idle state and client device 104₂ requiring the additional processing capability.

In one or more embodiments, operation 406 may involve registering, through driver component 202₂ on client device 104₂ requiring the additional processing capability, processor 108₄ in the idle state with operating system 146₂ executing thereon following the establishment of the communication link. In one or more embodiments, operation 408 may then involve transmitting, through driver component 202₂, data to be processed through processor 108₄ in the idle state from client device 104₂ requiring the additional processing capability across computer network 106 following the registration.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a non-transitory machine-readable medium). For example, the various electrical structures and methods may be embodied using transistors, logic gates, and electrical circuits (e.g., application specific integrated (ASIC) circuitry and/or Digital Signal Processor (DSP) circuitry).

In addition, it will be appreciated that the various operations, processes, and methods disclosed herein may be embodied in a machine-readable medium and/or a machine accessible medium compatible with a data processing system (e.g., server 102). Accordingly, the specification and drawings are to be regarded in an illustrative rather than a restrictive sense.

What is claimed is:

1. A method comprising:
scanning, through a server, a plurality of client devices communicatively coupled to the server through a computer network for a processor thereof in an idle state based on activity therein falling below a threshold beyond a threshold period of time, each of the plurality of client devices including a processor communicatively coupled to a memory;
allocating, through the server, the processor in the idle state to a client device requiring additional processing capability to establish a communication link between a client device corresponding to the processor in the idle state and the client device requiring the additional processing capability;
registering, through a driver component on the client device requiring the additional processing capability, the processor in the idle state with an operating system executing thereon following the establishment of the communication link; and
transmitting, through the driver component, data to be processed through the processor in the idle state from the client device requiring the additional processing capability across the computer network following the registration.

2. The method of claim 1, comprising pooling processors in an idle state on the server as logical resources based on polling client devices corresponding thereto through the server.

3. The method of claim 1, further comprising transmitting a request for a processing resource from the client device requiring the additional processing capability to the server.

4. The method of claim 3, further comprising authenticating the client device requiring the additional processing capability based on an identifier thereof through the server following the receipt of the request thereat.

5. The method of claim 1, further comprising logically decoupling the processor previously in the idle state from the client device requiring the additional processing capability based on deregistering the processor from the operating system thereof when a processing task on the data transmitted to the processor is completed.

6. The method of claim 5, comprising logically decoupling the processor in accordance with a request therefor from another client device to the server.

7. The method of claim 1, comprising determining the idle state of the processor based on at least one of a clock cycle thereof and a power consumption therethrough.

8. A non-transitory medium, readable through a server and including instructions embodied therein that are executable through the server, comprising:
instructions to scan a plurality of client devices communicatively coupled to the server through a computer network for a processor thereof in an idle state based on activity therein falling below a threshold beyond a threshold period of time, each of the plurality of client devices including a processor communicatively coupled to a memory;
instructions to allocate the processor in the idle state to a client device requiring additional processing capability to establish a communication link between a client device corresponding to the processor in the idle state and the client device requiring the additional processing capability;
instructions to enable registering, through a driver component on the client device requiring the additional processing capability, the processor in the idle state with an operating system executing thereon following the establishment of the communication link; and
instructions to enable transmitting, through the driver component, data to be processed through the processor in the idle state from the client device requiring the additional processing capability across the computer network following the registration.

9. The non-transitory medium of claim 8, comprising instructions to pool processors in an idle state on the server as logical resources based on polling client devices corresponding thereto through the server.

10. The non-transitory medium of claim 8, further comprising instructions to receive a request for a processing resource from the client device requiring the additional processing capability.

11. The non-transitory medium of claim 10, further comprising instructions to authenticate the client device requiring the additional processing capability based on an identifier thereof following the receipt of the request.

12. The non-transitory medium of claim 8, comprising instructions to transmit a request for the previously idle processor utilized by the client device requiring the additional processing capability to an appropriate client device.

13. The non-transitory medium of claim 8, comprising instructions to determine the idle state of the processor based on at least one of a clock cycle thereof and a power consumption therethrough.

14. A system comprising:
a plurality of client devices, each of the plurality of client devices including a processor communicatively coupled to a memory;
a computer network; and
a server communicatively coupled to the plurality of client devices through the computer network, the server being configured to:
scan the plurality of client devices for a processor thereof in an idle state based on activity therein falling below a threshold beyond a threshold period of time, and
allocate the processor in the idle state to a client device requiring additional processing capability to establish a communication link between a client device corresponding to the processor in the idle state and the client device requiring the additional processing capability, and
a driver component on the client device requiring the additional processing capability being configured to enable:
registering the processor in the idle state with an operating system executing thereon following the establishment of the communication link, and
transmitting data to be processed through the processor in the idle state from the client device requiring the additional processing capability across the computer network following the registration.

15. The system of claim 14, wherein the server is configured to pool processors in an idle state thereon as logical resources based on polling client devices corresponding thereto.

16. The system of claim 14, wherein the client device requiring the additional processing capability is configured to transmit a request for a processing resource to the server.

17. The system of claim 16, wherein the server is further configured to authenticate the client device requiring the additional processing capability based on an identifier thereof following the receipt of the request thereat.

18. The system of claim 14, wherein the processor previously in the idle state is configured to be logically decoupled from the client device requiring the additional processing capability based on deregistering the processor from the operating system thereof when a processing task on the data transmitted to the processor is completed.

19. The system of claim 18, wherein the processor is logically decoupled in accordance with a request therefor from another client device to the server.

20. The system of claim 14, wherein the server is configured to determine the idle state of the processor based on at least one of a clock cycle thereof and a power consumption therethrough.
